(19) United States
(12) Patent Application Publication
(10) Pub. No.: US 2003/0202441 A1
(43) Pub. Date: Oct. 30, 2003

(54) Data recording controller

(76) Inventors: Takuya Shiraishi, Ogaki-shi (JP); Shin-ichiro Tomisawa, Gifu-ken (JP)

Correspondence Address: FISH & RICHARDSON PC, 225 FRANKLIN ST, BOSTON, MA, 02110, US

(21) Appl. No.: 10/422,158

(22) Filed: Apr. 24, 2003

(30) Foreign Application Priority Data
Apr. 25, 2002 (JP) 2002-124466

(51) Int. Cl. G11B 7/0045

(52) U.S. Cl. 369/47.34; 369/59.24

(57) ABSTRACT

A data recording controller for speedily modulating input data and generating modulated data. The controller includes a modulation circuit for modulating input data and generating modulation candidates. A selection circuit is connected to the modulation circuit to receive the modulation candidates from the modulation circuit and select one of the modulation candidates as the modulated data based on a conversion parameter. A plurality of memories simultaneously store the modulation candidates, respectively. An output circuit receives the modulation candidates read from the memories and outputs the modulated data, which the selection circuit selects from the modulation candidates.

### CROSS-REFERENCE TO RELATED APPLICATIONS

This application is based upon and claims the benefit of priority from prior Japanese Patent Application No. 2002-124466, filed on Apr. 25, 2002, the entire contents of which are incorporated herein by reference.

### BACKGROUND OF THE INVENTION

The present invention relates to a data recording controller, and more particularly, to a data recording controller for controlling a recording operation performed by a data recorder that records data on a recording medium, such as an optical disc.

Generally, data that is subject to recording (original data) is not directly recorded on a recording medium. The original data undergoes modulation, and the modulated data (write data) is recorded on the recording medium. Such modulation improves the recording density and suppresses DC components.

For example, a DVD recording device, which uses a disc, such as a digital versatile disc-recordable (DVD-R), records data as described below. In this specification, a data recordable recording medium, such as a DVD-R, will simply be referred to as a “DVD.”

Referring to FIG. 1, when recording data on a DVD, the data subject to recording (main data) is divided into units of 2048 bytes. A header consisting of 12 bytes is added to the head of each piece of main data. An error detection code (EDC) consisting of 4 bytes is added to the end of the main data. This configures a data sector having 2064 bytes. The data sector is configured by 12 rows, each having 172 bytes (172 bytes×12 rows).

Referring to FIG. 2, a single block is defined by 16 successive data sectors (i.e., 172 bytes×192 rows). An error correction code (ECC), which is configured by 16 rows of an outer code parity (PO) and 10 columns of an inner code parity (PI), is added to the block. This configures an ECC block with 208 rows, each having 182 bytes (182 bytes×208 rows).

Referring to FIG. 3, each of the 16 rows in the PO, to which the PI is added, is sequentially moved to a position following one of the data sectors (12 rows). This configures recording sectors, each having 13 rows of 182 bytes (182 bytes×13 rows). The data of each recording sector is modulated to write modulated data on the DVD.

Data is modulated in the following manner. First, one byte of data (i.e., 8 bits) is converted to 16 bits of data, which are associated to the byte by a conversion table. In the 16 bits of table-converted data, there are two to ten “0's” between two bits having the value of “1”. The 16 bits of data undergoes non return to zero inverted (NRZI) conversion. The NRZI conversion inverts each of the 16 bits of data whenever “1” appears immediately before the bit. After undergoing table conversion and NRZI conversion in this manner, the 8 bits of data undergo 8-16 modulation to generate 16 bits of modulated data.

A plurality of conversion tables are used to perform the table-conversion. In the conversion table, 16 bits of data is associated with a given 8 bits of data, and a conversion table number (next state, i.e., NST) is designated for the next 8 bits of data. In this manner, an NST is designated as 16 bits of data corresponding to a single piece of 8-bit data is designated. Thus, table conversion and 8-16 conversion is performed successively on a series of data streams to obtain a modulated data stream. Instead of just one NST, multiple NSTs may be designated immediately after data conversion is performed on 8 bits of data.

Hereafter, the table conversion and NRZI conversion performed on a single piece of 8-bit data will be referred to as “8-16 modulation” or simply “modulation.” Further, the 16 bits of data actually written to a DVD is referred to as “modulated data,” and 16-bit data that has not been determined as to whether it should be written to a DVD is referred to as a “modulation candidate.”

FIG. 4 illustrates an example in which a data stream is modulated to generate a data stream that serves as a modulation candidate when multiple NSTs are designated. FIG. 4A illustrates a data stream, and FIG. 4B illustrates a series of conversion candidates (streams) generated by modulating the data stream. In FIG. 4B, the number of NSTs obtained through table conversion is shown under each modulation candidate.

Data A is modulated to generate modulated data A and two NSTs. Based on the two NSTs, the next data B1 is modulated using two conversion tables to generate a modulation candidate B1x and a modulation candidate B1y. In this state, one NST is designated for each of the modulation candidates B1x and B1y. Accordingly, data B2 is modulated based on the NST designated to the modulation candidate B1x to generate a modulation candidate B2x, and data B2 is modulated based on the NST designated to the modulation candidate B1y to generate a modulation candidate B2y. One NST is designated for each of the modulation candidates B2x and B2y.

In this manner, when there are two NSTs designated to a single piece of data, a plurality of modulation candidates are generated. This generates stream X, which includes the modulation candidate B1x, and stream Y, which includes the modulation candidate B1y.

Presuming that the modulation of data Bn generates a modulation candidate Bnx in the stream X and designates two NSTs, three or four modulation candidates would be generated subsequently in the stream X and the stream Y. Accordingly, to limit the number of modulation candidates to two, a limiting process is performed to validate one of the streams and invalidate the other one of the streams prior to the modulation of data C1.

In the limiting process, a digital sum variation (DSV) value is calculated from each of the streams X and Y. The calculated DSV value is referred to as a conversion parameter to validate one of the streams. The DSV value represents a DC component, which is included in a signal written to the disc medium. The DSV value is calculated whenever 8 bits of data are converted to 16 bits of data. Further, DSV values are sequentially added as the conversion of data proceeds. Accordingly, one of the streams X and Y is validated in accordance with the DSV value obtained when the last modulation candidate (Bnx and Bny) in each stream is generated.

When the stream X is validated as a result of the limiting process, the modulation candidates B1x to Bnx included in the stream X are selected as the modulated data. In other words, among the two modulation candidate groups generated by modulating 8-bit data to 16-bit data, one group is selected as the modulated data.

If it is determined that stream Y is to be invalidated, predetermined data is written (a mark is added) to the first modulation candidate B1y of the stream Y so that the invalidation of the stream Y may be recognized. This generates two modulation candidates C1x0 and C1x1 and selects the modulation candidate stream B1x to Bnx, which configure the stream X, as the modulated data of data stream B1 to Bn.

In this manner, the DVD recording device generates two streams of modulation candidates when performing 8-16 modulation on data that is subject to recording. Thus, a data recording controller must function to store two streams and output the stream that is selected as the modulated data.

FIG. 5 is a schematic block diagram of a data recording controller 100 for a data recording device. The data recording controller 100 includes a data fetch circuit 41, an 8-16 modulation circuit 42, a stream controller 43, a static random access memory (SRAM) 44, a parallel/serial (P/S) conversion circuit 45, and a memory access circuit 46.

The data fetch circuit 41 fetches 8 bits of data and provides the 8-bit data to the 8-16 modulation circuit 42. The 8-16 modulation circuit 42 modulates the 8-bit data using a conversion table corresponding to the presently designated NST. In this state, two modulation candidates respectively corresponding to the two data streams are normally generated.

The stream controller 43 receives the two modulation candidates from the 8-16 modulation circuit 42 and stores the two modulation candidates in its latch circuit. Further, the stream controller 43 stores the two modulation candidates in the SRAM 44 through the memory access circuit 46. When it becomes necessary to perform the limiting process on the modulation candidates, the stream controller 43 refers to a DSV value and selects one of the two modulation candidates read from the latch circuit to determine the modulated data. Then, the stream controller 43 accesses the SRAM 44 through the memory access circuit 46 and adds a mark to the modulation candidate that was not selected. The 8-16 modulation circuit 42 and the stream controller 43 each have a latch circuit to store two to four modulation candidates and their DSV values. Further, the SRAM 44 includes two ring buffers, each of which has a predetermined memory capacity.

The P/S conversion circuit 45 reads the modulated data, which is selected by the stream controller 43, and the modulation candidates, which are generated in parallel to the modulated data, from the SRAM 44 in an orderly manner to perform P/S conversion on the selected modulated data and output the converted data in serial. The memory capacity of the two ring buffers in the SRAM 44 is set so that the stream controller 43 may select one of the two modulation candidates as the modulated data.

The data recording controller 100 performs a series of processes in synchronism with a clock signal generated from a synchronization signal read from the DVD. The modulated data is also output from the data recording controller 100 in units of single bits synchronously with the clock signal. Accordingly, since 8 bits of data are converted to 16 bits of modulated data, 16 clock periods are necessary to output the 16 bits when recording a single piece of 8-bit data. Thus, for a single piece of 8-bit data, the time from when the data fetch circuit 41 fetches data to when the P/S conversion circuit 45 reads a modulation candidate from the SRAM 44 must be within 16 clock periods.

FIG. 6 illustrates the processes performed by the data recording controller 100 in units of processing steps that are synchronized with the clock signal. It is assumed here that two NSTs are obtained from a single piece of modulated data.

In step 1, the data fetch circuit 41 fetches data. Then, in step 2, the 8-16 modulation circuit 42 performs table conversion on the fetched data with the designated conversion tables to generate two modulation candidates and provides the two modulation candidates to the stream controller 43. Subsequently, the stream controller 43 stores the two modulation candidates in the latch circuit and the SRAM 44. Further, the stream controller 43 selects one of the streams based on the two modulation candidates as data in steps 5 and 6. In step 7, a mark is added to the invalid stream. In step 8, the stream controller 43 executes various operations so that modulation is performed continuously. Finally, in steps 9 and 10, the P/S conversion circuit 45 reads two pieces of data (modulated data and invalid stream) from the SRAM 44.

It is desired that the operating speed of the DVD recording device be improved to record a large volume of data on a DVD. Thus, it is desirable that the processing speed of the data recording controller 100 be increased. To improve the processing speed of the data recording controller 100, the operating frequency of the data recording controller 100 must be increased. However, it is difficult to increase the speed of each process due to the hardware configuration, which includes logic circuits. The operating frequency for processing only the output of bit pulse streams from the P/S conversion circuit 45 may be increased. However, in such a case, if the processing speed cannot follow the operating frequency from when the data fetch circuit 41 fetches data to when the P/S conversion circuit 45 reads data from the SRAM 44, the data recording controller 100 would not be able to smoothly perform the series of processes.

### SUMMARY OF THE INVENTION

One aspect of the present invention is a data recording controller for modulating input data and generating modulated data. The data recording controller includes a modulation circuit for modulating input data and generating a plurality of modulation candidates. A selection circuit is connected to the modulation circuit to receive the modulation candidates from the modulation circuit and select one of the modulation candidates as the modulated data based on a conversion parameter. A plurality of memories simultaneously store the modulation candidates, respectively. An output circuit reads and receives the modulation candidates from the memories and outputs the modulated data, which the selection circuit selects from the modulation candidates.

A further aspect of the present invention is a data recording controller for modulating input data to generate modulated data. The data recording controller includes a modulation circuit for modulating input data and generating a plurality of modulation candidates. A selection circuit is connected to the modulation circuit to receive the modulation candidates from the modulation circuit and select one of the modulation candidates as the modulated data based on a conversion parameter. A plurality of memories simultaneously store the modulation candidates, respectively, at different addresses. An output circuit reads and receives the modulation candidates from the memories and outputs the modulated data, which the selection circuit selects from the modulation candidates.

A further aspect of the present invention is a method for modulating input data and generating modulated data. The method includes modulating the input data to generate a plurality of modulation candidates, simultaneously storing the modulation candidates in a plurality of memories, respectively, selecting one of the modulation candidates as the modulated data based on a conversion parameter, simultaneously reading the modulation candidates from the memories, and outputting the modulated data selected from the read modulation candidates.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram illustrating a data sector of a DVD;

FIG. 2 is a diagram illustrating an ECC block of the DVD;

FIG. 3 is a diagram illustrating a recording sector in which rows of an ECC block have been shifted;

FIG. 4A illustrates a data stream that is to be modulated, and FIG. 4B is a diagram illustrating the generation of streams through 8-16 modulation;

FIG. 5 is a schematic block diagram of a data recording controller for a DVD in the prior art;

FIG. 6 is a diagram illustrating processing steps performed by the data recording controller of FIG. 5;

FIG. 7 is a schematic block diagram of a data recording controller according to a preferred embodiment of the present invention;

FIG. 8 is a diagram illustrating processing steps performed by the data recording controller of FIG. 7; and

FIG. 9 is a diagram illustrating the pipelined process of FIG. 8.

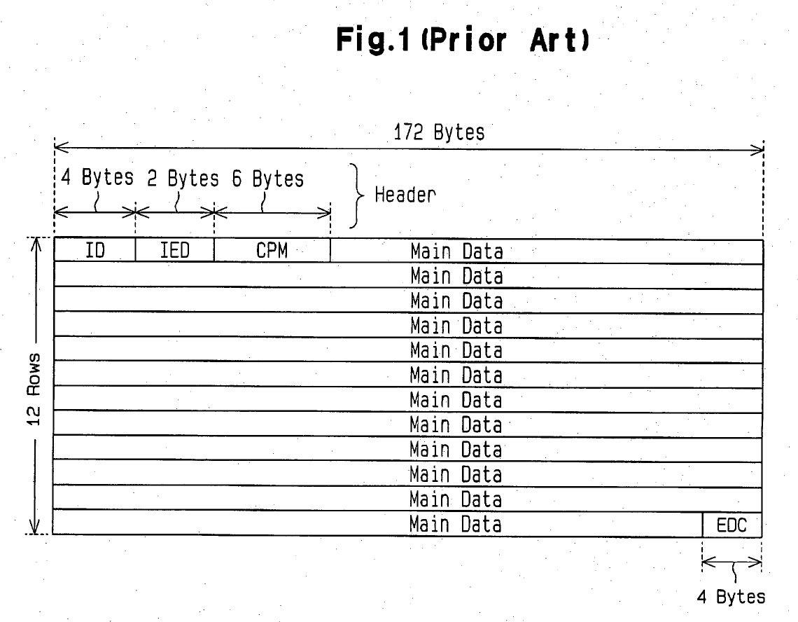

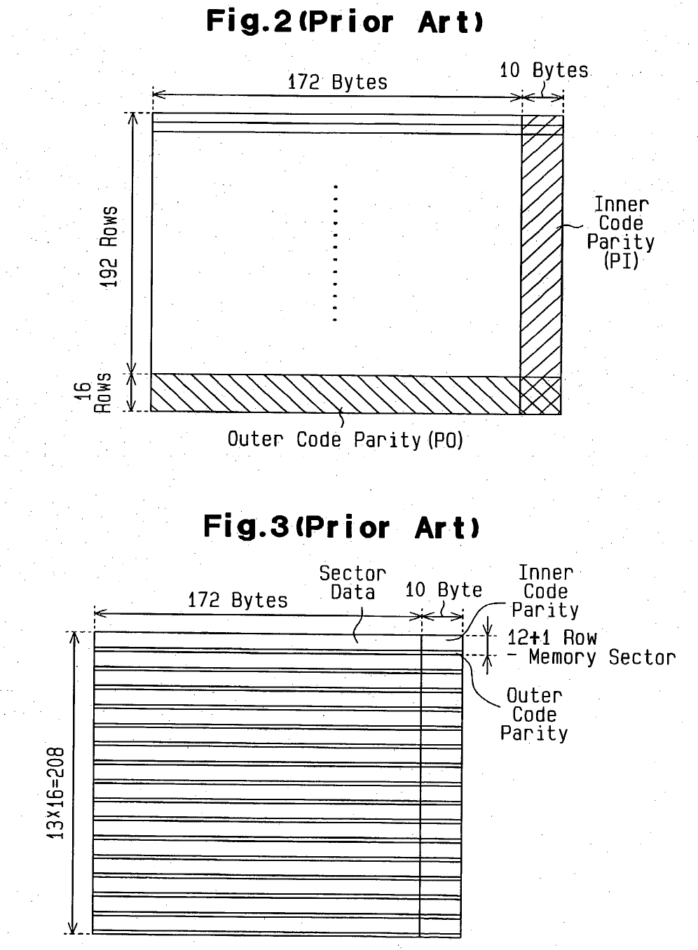

### DETAILED DESCRIPTION OF THE PREFERRED EMBODIMENTS

In the drawings, like numerals are used for like elements throughout.

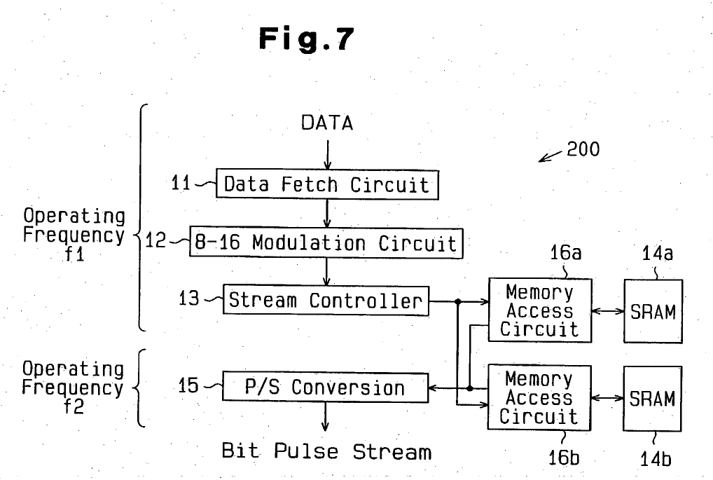

Referring to FIG. 7, a data recording controller 200 for a DVD recording device according to a preferred embodiment of the present invention includes a data fetch circuit 11, an 8-16 modulation circuit 12, a stream controller 13, SRAMs 14a and 14b, a parallel/serial (P/S) conversion circuit 15, and memory access circuits 16a and 16b.

The data fetch circuit 11 fetches 8 bits of data and provides the 8-bit data to the 8-16 modulation circuit 42. The 8-16 modulation circuit 12 modulates the 8-bit data using a conversion table corresponding to an NST as the presently designated conversion parameter. In this state, two modulation candidates respectively corresponding to two data streams are normally generated.

The stream controller 13 receives the two modulation candidates from the 8-16 modulation circuit 12 and stores the first modulation candidate in a predetermined section of the SRAM 14a, which corresponds to the first stream, through the memory access circuit 16a so that the first modulation candidate is added to the first stream. Further, the stream controller 13 stores the second modulation candidate in a predetermined section of the SRAM 14b, which corresponds to the second stream, through the memory access circuit 16b so that the second modulation candidate is added to the second stream. The SRAMs 14a and 14b each include a ring buffer having enough memory capacity for storing the corresponding stream. The memory access circuits 16a and 16b each control the input and output of the modulation candidate for the associated SRAM.

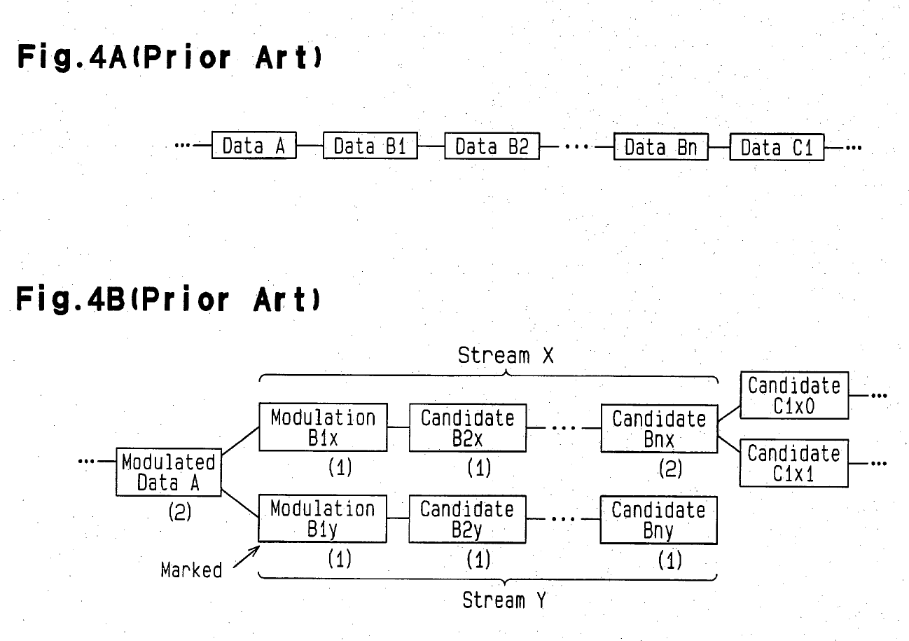

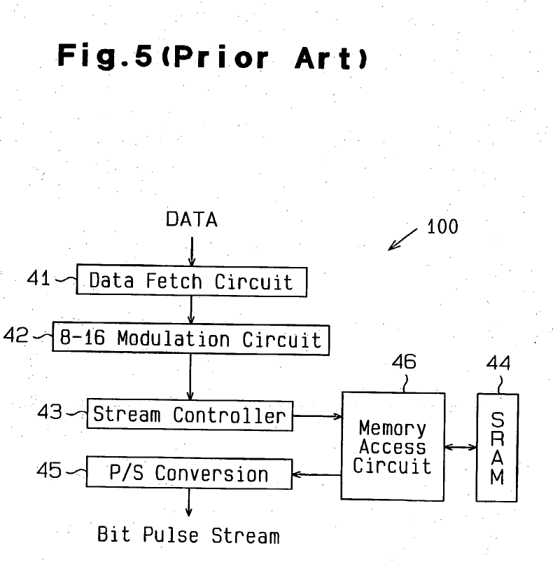

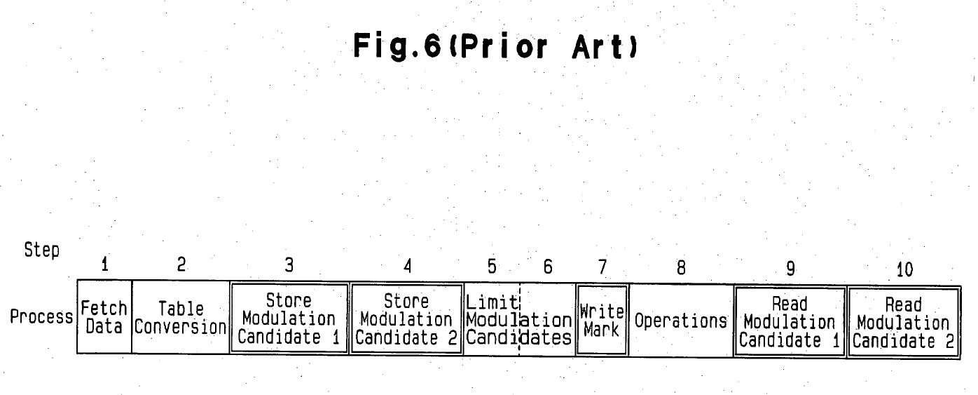

The P/S conversion circuit 15 simultaneously receives the two modulation candidates from the SRAMs 14a and 14b through the memory access circuits 16a and 16b, performs parallel/serial (P/S) conversion on the one of the two modulation candidates that is selected as the modulated data, and outputs the P/S-converted data. The modulated data is determined by performing the conventional limiting process illustrated in FIG. 4B on the two modulation candidates generated by the 8-16 modulation circuit 12. That is, the P/S conversion circuit 15 performs P/S conversion on the modulation candidate that is selected as the modulated data from the two modulation candidates read from the SRAMs 14a and 14b based on the mark added to the invalid stream when performing the limiting process of the modulated data. The memory capacity of the ring buffer in each of the SRAMs 14a and 14b is set so that the stream controller 13 may select one of the two modulation candidates as the modulated data until the P/S conversion circuit 15 starts to read the two modulation candidates from the SRAMs 14a and 14b.

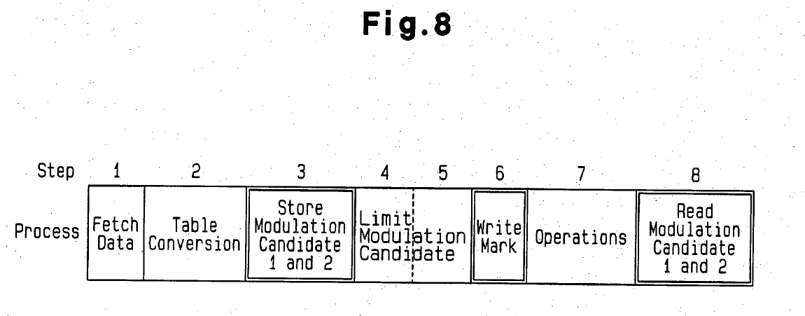

The data recording controller 200 of the DVD recording device performs processing in synchronism with a clock signal generated based on a synchronization signal, which is detected as the DVD rotates. FIG. 8 illustrates the processes performed by the data recording controller 200 in units of processing steps that are synchronized with the clock signal. In step 1, the data fetch circuit 11 fetches data from a DRAM (not shown) connected to the data recording controller 200. In step 2, the 8-16 conversion circuit 12 modulates 8-bit data with two conversion tables respectively corresponding to the presently designated NSTs and provides two modulation candidates to the stream controller 13. Then, in step S3, the stream controller 13 simultaneously stores the two modulation candidates in the two SRAMs 14a and 14b, respectively. Since there are two SRAMs 14a and 14b, two modulation candidates are simultaneously stored in the two SRAMs 14a and 14b in the same processing step. The stream controller 13 selects one of the two streams, which includes two modulation candidates, respectively, as modulated data in steps 4 and 5. In step 6, a mark is added to the invalidated stream. In step 7, the stream controller 13 executes various operations so that modulation is performed continuously. Finally, in step 8, the P/S conversion circuit 15 simultaneously reads two modulation candidates from the SRAMs 14a and 14b. In this state, the SRAMs 14a and 14b respectively correspond to the two streams. Thus, two modulation candidates are simultaneously read from the SRAMs 14a and 14b in the same processing step.

The SRAMs 14a and 14b each have the same address map. Thus, the P/S conversion circuit 15 simultaneously generates addresses, which are used to store and read data from the SRAMs 14a and 14b, with a single circuit and provides the addresses to the SRAMs 14a and 14b through the memory access circuits 16a and 16b. Accordingly, the circuit configuration of the P/S conversion circuit 15 is simplified.

In this manner, the data recording controller 200 performs the above series of processes in eight steps. Further, due to the pipelining, the data recording controller 200 processes two pieces of successive data in parallel. In other words, the pipelining performs the series of processes in substantially four steps.

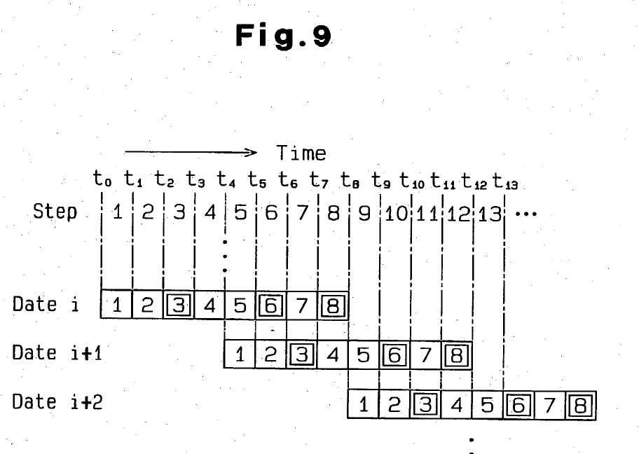

FIG. 9 is a diagram illustrating a pipelined series of processes performed on data i and the following data. In FIG. 9, the processing step of each piece of data is represented by a number surrounded by a square, and the processing step in which the SRAMs 14a and -14b are accessed are surrounded by two squares.

As shown in FIG. 9, the data recording controller 200 first performs the processing of steps 1 to 4 on data i during the period of time t0 to time t4. Then, the data recording controller 200 performs the processing of step 5 on data i during the period of time t4 to time t5. Further, the data recording controller 200 performs the processing of step 1 on data (i+1) parallel to the process of step 5. The data recording controller 200 performs the processing of step 6 on data i during the period of time t5 to time t6. Parallel to the processing of step 6, the data recording controller 200 performs the processing of step 2 on the data (i+1). In this manner, the processing of data i and data (i+1) are performed in parallel. Thus, during the period of time t4 to t8, the processing of steps 5 to 8 on data i and the processing of steps 1 to 4 on data (i+1) are performed. Then, during the period of time t8 to time t12, the processing of steps 5 to 8 on data (i+1) and the processing of steps 1 to 4 on data (i+2) are performed.

The stream controller 13 and the P/S conversion circuit 15 cannot simultaneously access the SRAMs 14a and 14b. Accordingly, the exclusive accessing to the SRAMs 14a and 14b for parallel data prevents simultaneous accessing of the stream controller 13 and the P/S conversion circuit 15 (refer to the steps of the double squares in FIG. 9) in the pipelined series of processes. Due to such pipelining, the data recording controller 200 virtually performs processing on a single piece of data in four steps.

In the data recording controller 200, the series of processes from the fetching of data with the data fetch circuit 11 (step 1) to the reading of the modulation candidates with the P/S conversion circuit 15 (Step 8), as shown in FIG. 8, are performed under operating frequency f1. The output of the P/S-converted modulated data (pit pulse stream) from the P/S conversion circuit 15 is performed under operating frequency f2. The relationship between the operating frequency f2 and the operating frequency f1 is preferably f2=4×f1.

In this manner, by setting the operating frequency f2 for the outputting process of the bit pulse stream to four times the operating frequency f1 of the series of processes including the 8-16 modulation performed in four steps, the reading of the modulation candidates of the P/S conversion circuit 15 and the output of the bit pulse stream are performed smoothly.

The data recording controller 200 of the preferred embodiment has the-advantages described below.

(1) The data recording controller 200 includes the SRAMs 14a and 14b, each storing one of two streams generated during data modulation. Thus, two modulation candidates respectively included in two streams are stored in the SRAMs 14a and 14b and read from the SRAMs 14a and 14b in the same processing step. Accordingly, the series of processing from the fetching of data with the data fetch circuit 11 to the reading of data from the SRAMs 14a and 14b with the P/S conversion circuit 15 is performed in eight steps, which is less than the ten steps of the prior art.

(2) The SRAMs 14a and 14b have the same address map. Thus, the stream controller 13 not only generates the same access address for the two SRAMs 14a and 14b but also simplifies the circuit configuration that is required for address generation.

(3) The series of processes from the fetching of data with the data fetch circuit 11 to the reading of data from the SRAMs 14a and 14b with the P/S conversion circuit 15 are pipelined. Thus, eight processing steps are substantially performed in four steps.

(4) The P/S conversion circuit 15 outputs the modulated data obtained from the series of processes without any interruptions in the bit pulse stream in accordance with its processing speed.

(5) The operating frequency f2 of the P/S conversion circuit 15 for outputting a bit pulse stream is set to four times the operating frequency f1 of the series of processes. Thus, the P/S conversion circuit 15 outputs bit pulse streams at a high speed. Further, even when increasing the operating frequency f2, the margin in terms of time increases for the series of processes performed under the operating frequency f1. As a result, the P/S conversion circuit 15 smoothly performs the reading of data and the outputting of a bit pulse stream. Further, by setting the operating frequency f2 to four times the operating frequency f1, the configuration of the clock signal, which generates the operating frequencies f1 and f2, is simplified.

It should be apparent to those skilled in the art that the present invention may be embodied in many other specific forms without departing from the spirit or scope of the invention. Particularly, it should be understood that the present invention may be embodied in the following forms.

The SRAMs 14a and 14b may have different address maps. In other words, the accessing of a memory section in the SRAM 14a in accordance with a first address and the accessing of a memory section in the SRAM 14b in accordance with a second address, which differs from the first address, may be performed simultaneously.

The series of processes do not have to pipelined. For example, when the series of processes are performed in eight steps, the operating frequency for outputting the bit pulse stream may be set to two times the operating frequency for the series of processes. In this case, the P/S conversion circuit 15 also smoothly performs the reading of modulation candidates and the output of the bit pulse stream.

Instead of the two SRAMs 14a and 14b, a mulitport SRAM, which enables simultaneous accessing of two memory sections, may be employed. Further, a semiconductor memory other than an SRAM may be used.

The operating frequency f2 for outputting the bit pulse stream with the P/S conversion circuit 15 may be set to two times the operating frequency f1 of the series of processes or may be set to be the same as the operating frequency f1 instead of being set to four times.

The P/S conversion circuit 15 may be located outside the data recording controller 200 and have it function cooperatively with the data recording controller 200.

The application of the present invention is not restricted to the data recording controller 200 of the DVD recorder. The present invention may also be applied to a data recording controller for a data recording device that records one of a plurality of modulation candidates generated during data modulation to a recording medium.

The present examples and embodiments are to be considered as illustrative and not restrictive, and the invention is not to be limited to the details given herein, but may be modified within the scope and equivalence of the appended claims.

What is claimed is:

1. A data recording controller for modulating input data and generating modulated data, the data recording controller comprising:
a modulation circuit for modulating input data and generating a plurality of modulation candidates;
a selection circuit connected to the modulation circuit to receive the modulation candidates from the modulation circuit and select one of the modulation candidates as the modulated data based on a conversion parameter;
a plurality of memories for simultaneously storing the modulation candidates, respectively; and
an output circuit for reading and receiving the modulation candidates from the memories and outputting the modulated data, which the selection circuit selects from the modulation candidates.

2. The data recording controller according to claim 1, wherein the memories store the modulation candidates during the same processing step period, which is synchronized with a predetermined clock signal.

3. The data recording controller according to claim 1, further comprising:
a plurality of access circuits respectively connected to the memories to control input and output of the modulation candidates for the associated memories.

4. The data recording controller according to claim 3, wherein the selection circuit is connected to the access circuits to generate a common access address for the memories and provide the access address to the access circuits.

5. The data recording controller according to claim 1, wherein the memories each have the same memory capacity and the same address map.

6. The data recording controller according to claim 5, wherein the selection circuit generates a common access address and provides the access address to a plurality of access circuits.

7. The data recording controller according to claim 1, wherein the modulation circuit and the selection circuit operate under a first operating frequency, and the output circuit converts the modulated data to serial modulated data under a second operating frequency, which is a predetermined multiple of the first operating frequency.

8. The data recording controller according to claim 1, wherein the output circuit simultaneously receives the modulation candidates read from the memories.

9. A data recording controller for modulating input data to generate modulated data, the data recording controller comprising:
a modulation circuit for modulating input data and generating a plurality of modulation candidates;
a selection circuit connected to the modulation circuit to receive the modulation candidates from the modulation circuit and select one of the modulation candidates as the modulated data based on a conversion parameter;
a plurality of memories for simultaneously storing the modulation candidates, respectively, at different addresses; and
an output circuit for reading and receiving the modulation candidates from the memories and outputting the modulated data, which the selection circuit selects from the modulation candidates.

10. The data recording controller according to claim 9, wherein the memories store the modulation candidates during the same processing step period, which is synchronized with a predetermined clock signal.

11. The data recording controller according to claim 9, wherein the modulation circuit and the selection circuit operate under a first operating frequency, and the output circuit converts the modulated data to serial modulated data under a second operating frequency, which is a predetermined multiple of the first operating frequency.

12. A method for modulating input data and generating modulated data, the method comprising:
modulating the input data to generate a plurality of modulation candidates;
simultaneously storing the modulation candidates in a plurality of memories, respectively;
selecting one of the modulation candidates as the modulated data based on a conversion parameter;
simultaneously reading the modulation candidates from the memories; and
outputting the modulated data selected from the read modulation candidates.

13. The method according to claim 12, further comprising:
generating a common access address for the memories that is used in said storing the modulation candidates and said reading the modulation candidates.

14. The method according to claim 12, wherein said generating, said storing, said selecting, and said reading are performed in a pipelined manner.

15. The method according to claim 14, wherein said generating and said selecting are performed under a first operating frequency, and said outputting is performed under a second operating frequency, which is greater than the first operating frequency.
